(19) United States
(12) Patent Application Publication
(10) Pub. No.: US 2005/0182822 A1
(43) Pub. Date: Aug. 18, 2005

(54) Imaging device with memory device interface

(76) Inventors: Stuart W. Daniel, Lexington, KY (US); Steven F. Weed, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/781,529

(22) Filed: Feb. 17, 2004

(51) Int. Cl. G06F 15/167

(52) U.S. Cl. 709/213

(57) ABSTRACT

An imaging device having a removable media interface. The removable media interface can read from and/or write to the removable media. The removable media interface can be directly integrated into the imaging device or in can be indirectly coupled to the imaging device. The removable media can be used to, among other things, update codes on the imaging device, configure the imaging device, provide user authentication, provide access to other information, such as an address book, encryption, personal preferences, and/or documents. Documents or other stored information can be written to the storage device at a remote location or written to the storage device at the imaging device.

### BACKGROUND

Imaging devices, such as printers, scanners, multifunctional printers, and the like, can be networked to several computers within a business. Frequently, service functions, such as updating the firmware need to be performed on these devices.

Moreover, some imaging devices have multifunctional capabilities. For example, they may be able to scan items, copy items, email items, and/or fax items. Some of these functions, such as scanning and faxing may require routing or delivery information.

### SUMMARY OF THE INVENTION

Some imaging devices of the present invention, such as printers, scanners, copiers, facsimile machines, multifunctional printers, and the like, have a removable media interface. The imaging device can read from and/or write to the removable media via the interface. The removable media interface can be directly integrated into the imaging device or can be indirectly coupled to the imaging device via a conventional or proprietary connection. The removable media interface can include among other things a USB host interface, a USB-based card reader connected to the host USB port, a flash card reader, a conventional disc drive, or the like. The media can be a disc, a USB storage device (e.g., thumb drive or memory key), other memory cards, and the like.

The removable media or storage device can be used to update codes on the imaging device. For example, the firmware can be updated from a file stored on the media.

The removable media can be used to configure the imaging device. For example, both basic and advanced configuration options can be communicated from the media.

The removable media can be used to track information. For example, inventory or consumable use can be monitored on the media.

The removable media can be used to provide user authentication. For example, authentication on the media can allow a user access to files that have been downloaded to a printer from a computer and held within the printer memory. Additionally, it can authenticate a user at the imaging device to allow the user access to certain functions of the imaging device.

The storage device can contain additional information. For example, it can contain an address book, encryption, personal preferences, and/or documents. Documents or other stored information can be written to the storage device at a remote location, such as at a networked or non-networked computer, or information can be written to the storage device at the imaging device. In some embodiments, documents stored on the media can be supported at the imaging device without the need for a host computer to translate the document into a typical page description language (PDL).

Some embodiments are directed toward a method of updating firmware of an imaging device having a first communication port connectable with a computer or network for receiving information and a second communication port for reading information from a portable memory source. The method includes connecting the portable memory source to the second communication port and accessing files stored on the portable memory source. The firmware is then updated by at least one of the files stored on the portable memory source.

Some embodiments are also directed to a method of authenticating a user with a portable memory device and executing an operation based upon the authentication. The method includes providing an imaging device having a first communication port connectable with a computer or network and a second communication port connectable with the portable memory device. Authentication information and additional information other than authentication information may be saved to the portable memory device remotely. The portable memory device is connected with the second communication port, and authentication information is communicated from the portable memory device to the imaging device. The authentication information is then verified. The method further includes executing at least one operation at the imaging device using at least some of the additional information on the portable memory device.

Some embodiments are directed toward a method of printing a document. The method includes initiating a printing operation at a computer in a remote location from a printer and sending information to be printed from the computer to the printer. A portable memory device is connected with the printer and authentication information stored on the portable memory device is verified. A document is then printed with the information previously sent to the printer from the computer in response to verifying the authentication information.

Further aspects of the present invention, together with the organization and operation thereof, will become apparent from the following detailed description of the invention when taken in conjunction with the accompanying drawings.

### BRIEF DESCRIPTION OF THE DRAWINGS

FIG. 1 is a schematic diagram of an imaging device embodying aspects of the present invention.

FIG. 2 is a schematic diagram of an imaging device embodying aspects of the present invention.

### DETAILED DESCRIPTION OF THE ILLUSTRATED EMBODIMENTS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

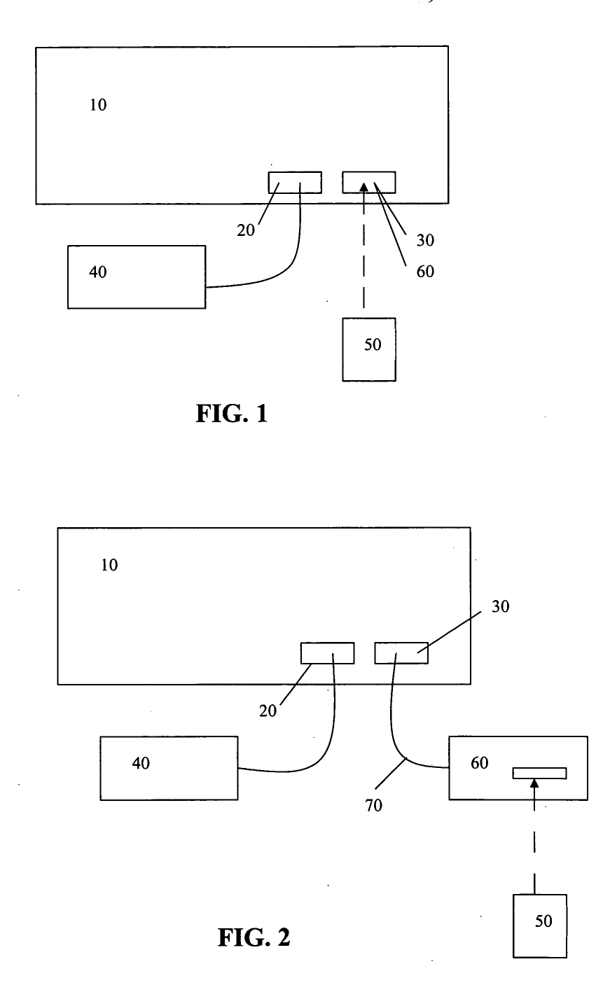

An imaging device 10 embodying aspects of the present invention is illustrated in FIGS. 1 and 2. The imaging device 10 can be a printer, scanner, copier, facsimile machine, multifunctional printer, and the like. As illustrated, the imaging device has at least two communication interfaces 20 and 30. The first communication interface 20 can utilize parallel or serial communications to connect the imaging device 10 to a computer 40, a network of computers, or the like. Information, such as status information, instructions, requests, image data, configuration information, and the like, can be communicated between the computer 40 and the imaging device 10. This interface 20 is well understood in the art, and therefore, it will not be further described.

The second communication interface 30 is adapted to communicate with a portable memory device or media 50 placed within a removable media interface 60. The imaging device 10 can read from and/or write to removable media 50 via the second communication interface 30. The second interface 30 can include a device or removable media interface 60 that is directly integrated into the imaging device 10 and capable of receiving one or more forms of removable media 50, as illustrated in FIG. 1. For example, a host Universal Serial Bus (USB) interface, such as those typically found on a personal computer can be incorporated in the imaging device 10 as part of the second communication interface 30. As such, a conventional USB storage device (e.g., thumb drives or memory keys) can be directly connected to the imaging device 10 by a user. Other interfaces can be incorporated into the imaging device instead of or in addition to the USB interface. These other interfaces can include a disc drive (for floppy discs, optical discs, and the like), a tape drive, a memory card reader, and/or other conventional interfaces adapted to receive removable media 50. These other interfaces can also include wireless, radio or infrared interfaces, such as those based on the Infrared Data Association (IrDA) or Bluetooth standards.

Alternatively, as illustrated in FIG. 2, the second interface 30 can provide a connection to one or more of the removable media interfaces 60 discussed above, wherein the removable media interfaces 60 are not integrated within the imaging device 10. Rather, the removable media interface 60 can be connected to the imaging device via an external communication line 70. The connection and communication line can be a conventional or proprietary. For example, a USB-based card reader can be connected to a host USB port 30 in the imaging device 10. Removable memory cards 50 could then be plugged into the reader by the user and communicate with the imaging device. The connection between the imaging device 10 and the media reading device 60 can be a disconnectable/plug-and-play connection in some embodiments. However, in other embodiments, the connection can be directly integrated into the imaging device 10.

Although the embodiment illustrated in FIG. 2 is described as being an alternative embodiment, the imaging device of some embodiments can include both a directly integrated removable media interface 60 as illustrated in FIG. 1 and an indirectly connected removable media interface 60 as illustrated in FIG. 2. For example, the imaging device can include both a host USB port and a card reader. These devices can be interconnected using an internal hub, such as a USB hub.

The type of removable media 50 used with respect to the second interface 30 is generally dependent upon the type of interface used. For example, thumb drives or memory keys can be used in embodiments incorporating USB-based card reader or host port.

The firmware of the imaging device 10 supports the media interface 30. For example, in the case of a USB-based media interface, support for the USB controller and storage specification is generally required. Imaging devices 10 based on a Linux kernal can usually provide the necessary support. In some embodiments, however, the firmware may be modified (i.e., customized) to support the media interface 30.

The firmware of the imaging device 10 can also be modified to recognize when removable media is coupled to the media interface 30. For example, the imaging device's application level firmware can include an interrupt handler, wherein the hardware can generate an interruption upon insertion of a media device 50. Alternatively, the imaging device 10 can periodically poll for new media. In some embodiments, however, the imaging device 10 can delay searching for media 50 until prompted by the user.

Once new media 50 is detected by the imaging device 10, it can be mounted by the application and the files on the media can be accessed. The imaging device 10 can automatically search the media upon detection or it can delay searching the media until prompted by the user. For example, searching can be delayed until a base operation is chosen by the user, such as printing a document, configuring the imaging device from a file, updating the firmware from a file, and the like.

Depending upon the configuration of the imaging device 10, it can search the media 50 for all files or just certain types of files corresponding to a particular command. The files can then be presented to the user for selection via a graphical user interface, for example.

The files can be searched may different ways. In one particular example, the files can be searched using the UNIX “find” command, which can look for files with known extensions. In a printer for example, the firmware could search for printer firmware updates (e.g., “.fls” file extension), printer configuration information (e.g., “.ucf” file extension), printer output file from a printer driver (e.g., “.prn” file extension), postscript documents (e.g., “.ps” file extension), Portable Document Format documents (e.g., “.pdf”file extension), image files (e.g., “jpg” or “.tif” file extensions), Hypertext Markup Language document (e.g., “.htm” file extension), and the like. The firmware can also search for other files. For example, it can search for user authentication information. A list of recognized files can be presented to the user via a user interface, such as a graphical user interface, and the user can then select one or more files to utilize.

In some embodiments, the memory device 50 can be used to update the firmware of the imaging device with files stored on the memory device 50. The update can be initiated several different ways. In some embodiments, the imaging device 10 can recognize a firmware update file and automatically update the firmware. In other embodiments, the user can prompt the update. For example, the user can choose to update the firmware as a base operation and have the memory device 50 searched for firmware update files, or the user can select one or more files on the memory device 50 that were detected through an automatic search. Once the user selects the appropriate file for execution, the flash file can be read from the media, verified, and routed to the appropriate application for updating the code.

Although the code can be updated many ways, some embodiments use File Transfer Protocol (FTP) to update the firmware. As such, verification and code updating can be handled through normal FTP paths.

Using an interface 30 and removable media to update firmware can avoid some security issues. Some conventional systems are updated by a vendor or user that does not have access the computer or computer network coupled to the imaging device. As such, this vendor is given temporary access to the computer or network coupled to the imaging device to perform the update. This temporary access can provide security issues. The present invention can avoid some security issues because the vendor does not need access to the computer or network coupled to the imaging device. Rather, the vendor only needs access to the imaging device.

In operation, a user wishing to update the firmware or code of the imaging device 10 can connect the media 50 with the removable media interface 60. As described above, the update can occur in one of many ways. For example, the imaging device 10 can recognize the presence of the media 50 and that the media contains a firmware update file. Then, the imaging device 10 can automatically update the firmware or it can prompt the user to initiate the firmware update. In other exemplary embodiments, the imaging device 10 may not search the media 50 until the user prompts an action requiring use of the media. For example, the user can indicate that he wishes to update the firmware (e.g., by choosing to update the firmware as a base operation). The imaging device 10 can then search the media 50 for update files. Upon finding an update file(s), the imaging device can automatically initiate the update or prompt the user to select one or more files detected in the search. In yet other exemplary embodiments, the user can manually search the media for update files. Once the appropriate file is selected for execution, the flash file can be read from the media, verified, and routed to the appropriate application for updating the code.

The configuration of the imaging device 10 can also be updated with the media 50. One or more configuration files can be stored on the media 50 for basic or advanced configuration of the imaging device 10. The configuration of the imaging device 10 can be permanently updated (i.e., until updated again) or temporarily updated (i.e., only while the media 50 is connected to the imaging device). The temporary configuration update can contain personalized settings for a specific user. This configuration operation can be initiated several different ways. In some embodiments, the imaging device 10 can recognize the configuration file(s) automatically and prompt the user to select a configuration file to execute. In other embodiments, the user can choose the base operation of configuring the imaging device and the imaging device can search the media for corresponding files. In yet other embodiments, the device 10 can display all files on the media 50, and the base operation can be initiated based upon the file selected by the user. Once the use selects the appropriate file for execution, the file can be read from the media, verified, and routed to configure the imaging device 10. Like the previous operation, this operation can be performed using existing paths, such as normal FTP paths.

In operation, a user wishing to update the configuration of the imaging device 10 may connect the media 50 with the removable media interface 60. As described above, the imaging device 10 can recognize the connection of the media 50 in one of many ways. Then, in some exemplary embodiments, the imaging device 10 can automatically search the media 50 and recognize the configuration file. The imaging device can either update the configuration automatically or it can prompt the user to initiate the configuration update, if desired. In other exemplary embodiments, the user can choose to initiate the update of the configuration via a graphical user interface. The imaging device 10 can then search the media 50 for update files. Upon finding an update file(s), the imaging device can automatically initiate the update or prompt the user to select one or more files detected in the search. In yet other exemplary embodiments, the user can manually search the media for update files. Once the appropriate file is selected for execution, the file can be read from the media, verified and routed to the appropriate application.

Documents, images, or other stored information can be printed from the media as well. This operation can be initiated by any of the different ways discussed above. Also, like the previous operation, this operation can be performed using existing paths, such as normal FTP paths.

In operation, a user wishing to print an item from the media at the imaging device 10 can connect the media 50 with the removable media interface 60. As described above, the imaging device 10 can recognize the connection of the media 50 in one of many ways. Then, in some exemplary embodiments, the imaging device 10 can automatically search the media 50 and display all recognized files. The recognized files can then be presented to the user for his selection. The imaging device can automatically perform an associated function, or it can prompt the user to further initiate one of many associated functions (e.g., print or fax). In other exemplary embodiments, the user can elect to print an item on a graphical user interface of the imaging device 10. Upon selecting this base operation, the imaging device 10 can then search the media 50 for all printable files. Upon finding all printable file(s), the imaging device can prompt the user to select one or more files to print. However, if only one printable file was saved to the media 50, the imaging device could be programmed to automatically print the file. In yet other exemplary embodiments, the user can manually search the media for the file or files he desires to print. Once the user selects the appropriate file for execution, the file can be read from the media, verified, and routed to the appropriate application to be printed.

Some embodiments of the imaging device can feature a secure print feature or a print-and-hold feature for printing personal, private, non-public, or “secure” documents. As used herein, the word document can include among other things text documents, image documents, combinations of the two, other items to be printed, and the like. Through this feature, a secure document can be sent to the printer directly from a computer or over a network, but the document will not print until an authenticated recipient is present at the printer to receive the document. Inserting a memory device 50 containing authentication information into the interface 30 can authenticate a user and complete the print job.

In some embodiments, the imaging device 10 can send an electronic signature file to the printer driver on the host computer upon receipt of a “secure” document. The print driver could then allow the user to save this signature to the media 50. Once the signature file is authenticated at the printer via the presence of the media 50, the corresponding document could be made available for printing. Alternatively, the signature file may be originated by the printer driver or another application on the host computer and downloaded with the secure document. In yet other embodiments, the media can be used as a “smart card” that can access user identification information stored on a network server. Once the user has been authenticated using this smart card, print jobs associated with the user can be released for printing.

In operation, a user wishing to print a secure document can initiate the secure print function from a computer. The document can be sent to the printer or to a server connected to the printer. To complete the secure printing operation, the user can connect the media 50 with the removable media interface 60 of the imaging device 10. An authentication operation is then performed at the imaging device. Any of the above described authentication techniques can be used, as well as other authentication techniques known in the art. If the user is authenticated, the printer can complete the print job by printing the document.

In some embodiments, authentication information stored on the media 50 can be used to prevent unauthorized access to the imaging device 10. In other words, all functions on the imaging device can be secured until the user is authenticated (e.g., “logged-on”) at the imaging device. In other embodiments, some features can be enabled for unauthenticated users, while select functions can be reserved for authenticated users only. For example, in some embodiments, users could be restricted from emailing scanned documents without first authenticating their identity through the use of the media 50. A “smart card” or the like can be used in some embodiments for quick authentication.

In yet other embodiments, functions on the imaging device can be permitted or prevented for a limited time or duration. In other words, some authentication information stored on the media 50 can be time sensitive or temporary and can be used to prevent unauthorized access to the imaging device 10. In other words, some features can be enabled or disabled temporarily. For example, in some embodiments, contractors hired to perform firmware updates could be granted access to the functions on the imaging device for only a few hours or a single day. In still other embodiments, the imaging device can renew or update the credentials stored on the media 50. For example, once a contractor accesses the system, the media can be updated to indicate the function has been performed and prevent further access or to reduce the amount of time remaining for system access. A “smart card” or the like can be used in some embodiments for quick authentication.

In operation, a user wishing to access secured functions on the imaging device 10 can connect the media with the removable media interface 60. The imaging device 10 could then automatically verify the user's authorization or wait for the user to prompt the verification. The user's authorization can be verified one or more ways discussed above. Upon verifying the user, previously secured functions of the imaging device can become available for use. Once the media is removed from the interface 60, the all or some of the functions can become secured again.

Some embodiments of the imaging device 10 can be capable of creating electronic documents. For example, some embodiments of the imaging device 10 can be a scanner or a multifunctional printer including a scanner. When the imaging device 10 scans hardcopy documents, they can be converted to an electronic format such as PDF, TIFF, or the like and then stored on the removable media 50. This can provide a walk-up scanning capability that is both convenient and secure since the scanned document is never visible on the network.

In operation, a user can initiate a scanning operation and prompt the imaging device to create an electronic document containing the scanned information on the media 50. In some embodiments, the imaging device 10 can automatically save the scanned electronic information to the media without being prompted.

When the imaging device 10 is a multifunctional printer having a scanner, the imaging device can have a printer controller and scanner controller with each having their own firmware. The firmware for each controller can be updated in a similar manner to the firmware updates previously discussed. Additionally, configuration settings (such as email server information, standard scan profiles, and the like) of the multifunctional printer can be updated using the same mechanism as discussed above.

In some embodiments, personal signatures may be stored on the media 50. For example, a user might keep their Gnu Privacy Guard (GPG) key ring (or other source-verifying tool) on a file of the media 50. Depending upon the configuration of the file, the user can enter their password via the media 50 at the imaging device 10 to sign electronic documents originated at the imaging device 10. The operation of this function can be performed similar to secure print function and/or the authentication function described above.

In some embodiments, personal address books can be stored on the media 50 and accessed at the imaging device 10. When the user accesses their address book from the user interface, the imaging device 10 can parse the file(s) to extract stored nicknames, addresses, groups, and the like. The extracted information can then be presented to the user to allow them to select the destination(s) of the document(s). This feature may be particularly useful for routing documents scanned to email.

In operation, a user wishing to access their personal address book at the imaging device 10 can connect the media 50 with the removable media interface 60. As described above, the imaging device 10 can recognize the connection of the media 50 in one of many ways. Then, in some exemplary embodiments, the imaging device 10 can automatically search the media 50 and display all recognized files. The recognized files can then be presented to the user for his selection. Upon selecting a file, the imaging device can automatically perform an associated function, or it can prompt the user to further initiate one of many associated functions. In other exemplary embodiments, the user can elect to email an item to a contact stored on the media 50. Upon selecting this base operation, the imaging device 10 can then search the media 50 for any files containing address books or other contact information. Upon finding all associated file(s), the imaging device can prompt the user to select one or more files. However, if only one file matches the desired parameters, the imaging device could be programmed to automatically access this file. In yet other exemplary embodiments, the user can manually search the media for the file or files he desires. Once the user selects the appropriate file, the contact information stored within the file can be accessed for use, such as emailing, faxing, and the like.

Some embodiments of the imaging device 10 can allow scan-to-network functions or scan-to-computer functions. The media 50 can be used to store scan-to-network profiles. Files having personal scan profile (e.g., “.psp” file extension) information can indicate network destinations, document formats, scan parameters and the like. Access to this information on the portable media 50 can allow a user to access nearly any imaging device on a corporate network and scan documents back to their computer, to other devices, or to their normal documents workflow process even if the imaging device is not normally used for that function. In operation, this function works in a similar manner to the address book function previously described. However, instead of searching for contact information, the imaging device 10 can search for personal profiles.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

Various features of the invention are set forth in the following claims.

1. A method of updating firmware of an imaging device having a first communication port connectable with a computer or network for receiving information and a second communication port for reading information from a portable memory source, the method comprising:
accepting a connection from the portable memory source at the second communication port;
accessing files stored on the portable memory source; and
updating the firmware with at least one of the files stored on the memory source.

2. The method of claim 1, further comprising recognizing the portable memory source upon connection with the second communication port.

3. The method of claim 1, further comprising generating an interruption signal upon connection of the portable memory source with the second communication port.

4. The method of claim 1, further comprising periodically polling for connection of the portable memory source at the second communication port.

5. The method of claim 1, further comprising searching the portable memory source for files.

6. The method of claim 5, wherein said files are all files that can be read by the imaging device.

7. The method of claim 5, wherein said files are files containing only firmware updates.

8. The method of claim 5, further comprising automatically selecting a file to update firmware.

9. The method of claim 5, further comprising presenting the files found in the search to a user.

10. The method of claim 9, further comprising receiving at least one selection from a user, said at least one selection corresponding to at least one of the files to update firmware.

11. The method of claim 8, further comprising verifying the contents of the selected file prior to updating the firmware.

12. The method of claim 1, further comprising selecting at least one of the files on the portable memory device to update the firmware.

13. The method of claim 1, wherein said connection between the portable memory device and the second communication port is a direct connection.

14. The method of claim 1, wherein said connection between the portable memory device and the second communication port is an indirect connection.

15. A method of authenticating a user with a portable memory device connectable to an imaging device, the method comprising:
communicating authentication information stored on the portable memory device to the imaging device; and
verifying the authentication information on the portable memory device.

16. The method of claim, 15, wherein said authentication information is stored on the portable memory device at a location remote from the imaging device.

17. The method of claim 15, further comprising printing at the imaging device a document stored from the portable memory device upon successful verification of the authentication information.

18. The method of claim 15, wherein said portable memory device contains additional information other than authentication information.

19. The method of claim 18, further comprising executing an operation at the imaging device using at least some of the additional information stored on the portable memory device upon successful verification of the authentication information.

20. The method of claim 15, further comprising updating configuration data on the imaging device from configuration information stored on the portable memory device upon successful verification of the authentication information.

21. The method of claim 20, wherein the configuration information stored on the portable memory device represents a user's configuration preferences.

22. The method of claim 20, wherein the configuration of the imaging device remains updated only while the portable memory device is connected to the imaging device.

23. The method of claim 15, further comprising updating the firmware of the imaging device from a file stored on the portable memory device upon successful verification of the authentication information.

24. The method of claim 15, further comprising accessing personal profile information and utilizing the personal profile information to complete a base operation at the imaging device.

25. The method of claim 15, further comprising accepting a connection from the portable memory device at a communication port on the imaging device.

26. The method of claim 25, wherein said connection is achieved through an interface directly connected to said communication port.

27. The method of claim 25, wherein said connection is achieved through an interface indirectly connected to said communication port.

28. The method of claim 15, wherein the authentication information is time sensitive.

29. The method of claim 28, further comprising updating said time sensitive authentication information when said portable memory device is connected to said imaging device.

30. A method of printing a document from a location remote from a printer, the method comprising:
receiving at said printer information to be printed;
accepting a connection from a portable memory device at the printer;
verifying authentication information stored on the portable memory device; and
upon verification, printing at the printer the received information.

31. The method of claim 30, wherein said connection from the portable memory device is a direct connection.

32. The method of claim 30, wherein said connection from the portable memory device is an indirect connection.

33. The method of claim 30, wherein verifying authentication information further comprises comparing said authentication information with information stored on a network server.
